(19) United States
(12) Patent Application Publication
(10) Pub. No.: US 2006/0009217 A1
(43) Pub. Date: Jan. 12, 2006

(54) System and method for product registration and activation

(76) Inventors: Christoffer Lunden, Espoo (FI); Andreas Hansson, Grankulla (FI); Mari Korkea-aho, Helsingfors (FI)

Correspondence Address: MORGAN & FINNEGAN, L.L.P., 3 WORLD FINANCIAL CENTER, NEW YORK, NY, 10281-2101, US

(21) Appl. No.: 10/878,889

(22) Filed: Jun. 28, 2004

(51) Int. Cl. H04Q 7/20

(52) U.S. Cl. 455/435.1

(57) ABSTRACT

Systems and methods whereby, for example, product registration and/or activation of a user's wireless node and/or other computer can be performed. Registration update may, for example, be performed. Further, systems and methods whereby, for example, a user's wireless node and/or other computer may allow her to make one or more options requests.

### FIELD OF INVENTION

This invention relates to systems and methods for computer provision.

### BACKGROUND INFORMATION

In recent years, computers (e.g., wireless nodes) have gained an increasingly prominent role in the lives of many people. For example, many people have come to rely upon computers to handle their media (e.g., movies, images, and/or music), their communications (e.g., text, voice, and/or video communications), their entertainment (e.g., video games), and/or the like.

In view, for instance, of this, there may be interest in technologies that, for example, facilitate the use of computers.

### SUMMARY OF THE INVENTION

According to embodiments of the present invention, there are provided systems and methods whereby, for example, product registration and/or activation of a user's wireless node and/or other computer can be performed. In various embodiments, registration update may be performed.

It is further noted that, according to various embodiments of the present invention, there are provided systems and methods whereby, for example, a user's wireless node and/or other computer may allow her to make one or more options requests.

### BRIEF DESCRIPTION OF THE DRAWINGS

FIG. 1 shows exemplary graphical user interface (GUI) screens according to various embodiments of the present invention.

FIG. 2 shows exemplary steps involved in registration and/or activation according to various embodiments of the present invention.

FIG. 3 shows exemplary data structure fields according to various embodiments of the present invention.

FIG. 4 shows further exemplary data structure fields according to various embodiments of the present invention.

FIG. 5 shows exemplary steps involved in options according to various embodiments of the present invention.

FIG. 6 shows an exemplary computer.

FIG. 7 shows a further exemplary computer.

### DETAILED DESCRIPTION OF THE INVENTION

General Operation

According to embodiments of the present invention, there are provided systems and methods whereby, for example, product registration and/or activation of a user's wireless node and/or other computer can be performed. In various embodiments, registration update may be performed.

In various embodiments, perhaps responsive to the user, the wireless node and/or other computer may communicate with one or more servers and/or the like to request registration and/or activation. One or more of such servers and/or the like might, in various embodiments, be associated with the manufacturer of the wireless node and/or other computer.

Via, for instance, action of the one or more servers and/or the like, the user's node and/or other computer can, for example, be registered, and/or the node and/or other computer can come to be activated.

Moreover, according to various embodiments of the present invention, there are provided systems and methods whereby, for example, a user's wireless node and/or other computer may allow her to make one or more options requests. Such an option request might, for example, convey a desire to receive manufacturer dialogue, product information, software updates, a startup pack, connectivity settings, and/or the like.

Various aspects of the present invention will now be discussed in greater detail.

Request for Registration and/or Activation

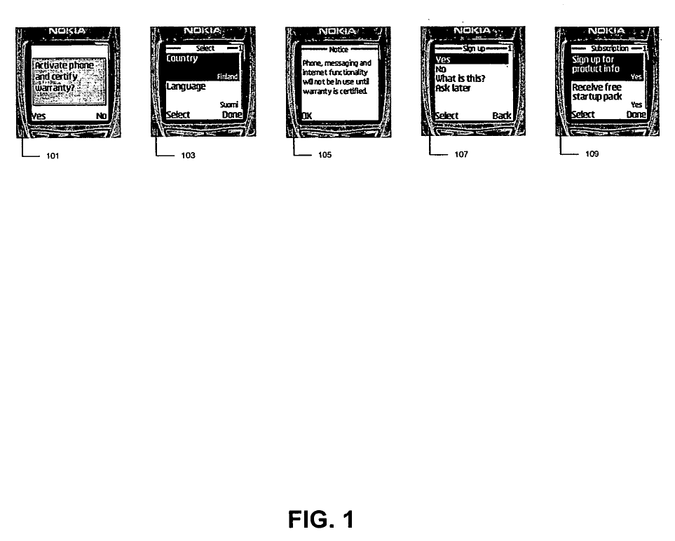

With respect to, FIG. 1 it is noted that, according to various embodiments of the present invention a user's wireless node and/or other computer (e.g., a new wireless node and/or other computer) may allow her to, perhaps via a GUI and/or other interface, indicate a desire to have product registration and/or activation performed for the wireless node and/or or other computer (screen 101). It is noted that, in various embodiments, registration and/or activation may include warranty certification, initiation, and/or the like.

In various embodiments the user might, upon the wireless node and/or other computer being turned on for the first time, upon the wireless node and/or other computer being turned on in the case where registration and/or activation has not been performed, and/or the like, receive an opportunity to indicate such a desire. The user could, in various embodiments, indicate that she wished to defer registration and/or activation to a later time. Responsive to such a selection the wireless node and/or other computer might, for instance, act to offer her the opportunity later (e.g., upon the phone being turned on, after a certain amount of time had passed, and/or the like), to not offer full product functionality, and/or the like.

Such functionality may be implemented in a number of ways. With respect to screen 103 of FIG. 1 it is noted that, according to various embodiments, the user's wireless node and/or other computer may, for example, provide her with a GUI and/or other interface she can employ to specify and/or confirm one or more nations, regions, languages, and/or the like to be associated with her wireless node and/or other computer for, for instance, product registration, use, and/or the like. It is noted that, in various embodiments, one or more dates (e.g., a date of purchase) might be determined. A specified nation, region, and/or the like might, for example, correspond to a nation, region, and/or the like where the wireless node and/or other computer was purchased, where it was activated, where it was to be used, and/or the like.

According to various embodiments, one or more nations, regions, languages, and/or the like might be suggested to the user, provided to the user as default selections, and/or the like. Such suggestions, defaults, and/or the like might, in various embodiments, be based on data held in memory accessible by the wireless node and/or other computer (e.g., a Subscriber Identity Module (SIM) card, wireless node and/or other computer memory, and/or the like), data received via a network connection or other connection, and/or the like. Alternately or additionally, in various embodiments, such suggestions, defaults, and/or the like might be based on a nation, region, and/or the like of purchase, use, and/or the like.

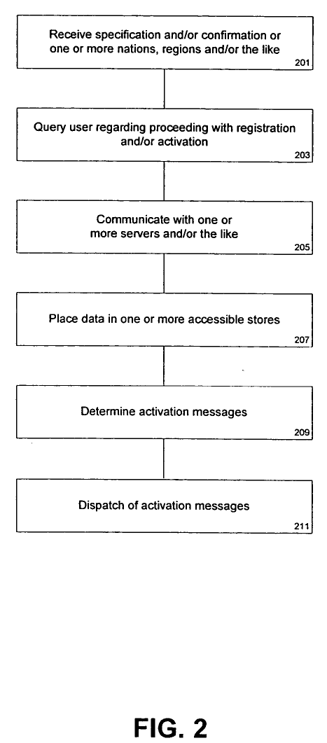

With respect to FIG. 2 it is noted that, in various embodiments, perhaps after having received the user's specification and/or confirmation of one or more nations, regions, languages, and/or the like (step 201), the wireless node and/or other computer could, perhaps via a GUI and/or other interface, query the user as to whether or not she wanted to proceed with registration and/or activation (step 203).

The wireless node and/or other computer might, in various embodiments, inform the user that use would be limited until registration and/or activation had been completed, that various functionality would be unavailable until registration and/or activation had been completed, and/or the like. With respect to screen 105 of FIG. 1 it is noted that, for example, the wireless node and/or other computer might, perhaps via a GUI and/or other interface, inform the user that telephone, messaging, and/or internet functionality would not be available until registration and/or activation had been completed.

The user might be so informed, for instance, in conjunction with being offered an opportunity to have registration and/or activation performed, upon attempting to use the wireless node and/or other computer, upon attempting to use the wireless node and/or other computer in a way that was not allowed due to limitation, and/or the like. In various embodiments, emergency calls, calls specified by local requirements, and/or the like might be allowed even in the case where calls were generally not allowed due to registration and/or activation not having been completed.

It is noted that, in various embodiments, the wireless node and/or other computer might act to request registration and/or activation without (e.g., via a GUI and/or other interface) informing its user that such request would take place and without querying its user for permission to do so. In various embodiments, the user might learn of such functionality via leaflets, point-of-sale agents, seals, stickers, and/or the like placed on the wireless node and/or other computer, and/or the like.

The wireless node and/or other computer might so act to request registration and/or activation, for example, immediately and/or shortly after initial startup. As another example, such functionality might be delayed. For instance, such functionality might take place a certain amount of time after initial startup of the wireless node and/or other computer (e.g., 60 minutes). Such an amount of time might, for instance, be set by a manufacture, a system administrator, a service provider, and/or the like.

It is further noted that, in various embodiments, the wireless node and/or other computer might act to (e.g., via a GUI and/or other interface) notify its user that it plans to request registration and/or activation, and to request that its user acknowledge receipt of such notification. The wireless node and/or other computer might so act to notify its user, for example, immediately and/or shortly after initial startup. As another example, such notification might be delayed. For instance, such notification might take place a certain amount of time after initial startup of the wireless node and/or other computer (e.g., 60 minutes). Such an amount of time might, for instance, be set by a manufacture, a system administrator, a service provider, and/or the like.

The wireless node and/or other computer might, for instance, act to request registration and/or activation after receiving such acknowledgement from its user. In various embodiments, one or more features (e.g., the ability to make telephone calls or non-emergency telephone calls) might be unavailable to the user until after registration and/or activation had taken place.

Perhaps after receiving a request to do so from the user, the wireless node and/or other computer could, in various embodiments, act to communicate with one or more servers and/or the like to request registration and/or activation (e.g., associated with the manufacturer of the wireless node and/or other computer) (step 205). According to various embodiments, such communication can be performed in a number of ways, and can include various data. For example, in various embodiments, such communication could involve the use of Short Message Service (SMS), Multimedia Messaging Service (MMS), Hypertext Transfer Protocol (HTTP), Simple Object Access Protocol (SOAP), Remote Method Invocation (RMI), Java Messaging Service (JMS), object push, and/or the like.

Data communicated to the one or more servers and/or the like could include, for example, one or more product identifiers (e.g., electronic serial numbers (ESNs), International Mobile Equipment Identity (IME) numbers, Media Access Control (MAC) addresses, Bluetooth identifiers, and/or the like) and/or the like associated with the wireless node and/or other computer. As further examples, data communicated to the one or more servers and/or the like could include one or more user identifiers, SIM identifiers, and/or the like, version information relating to software held by and/or installed on the wireless node and/or other computer, indication of one or more nations, regions languages, and/or the like (e.g., in accordance selection and/or confirmation by the user), indication of one or more operators, service providers and/or the like, indication of one or more option requests, indication of model of wireless node and/or other computer, a checksum, and/or the like. In various embodiments, version information could include speciation of one or more terminal software versions, operating system versions, and/or the like.

Indication of one or more operators, service providers, some or all of data discussed above, and/or the like might, in various embodiments, be in accordance with data held in memory accessible by the wireless node and/or other computer (e.g., a SIM card, wireless node and/or other computer memory, and/or he like), data received via a network connection and/or other connection, and/or the like. In various embodiments, a unique product registration/activation header and/or one or more activation messages could be included among data communicated to the one or more servers and/or the like.

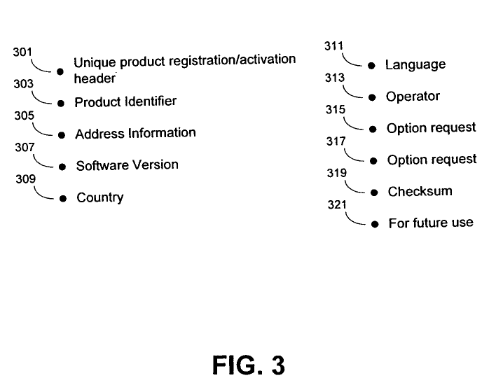

Shown in FIG. 3 are exemplary data structure fields employable in various embodiments of the present invention for such communications with the one or more servers and/or the like. Shown in FIG. 3 is unique product registration/activation header field 301, product identifier field 303, address information (e.g., phone number) field 305, software version field 307, country field 309, language field 311, operator field 313, option request field 315, option request field 317, checksum field 319, and future use field 321. It is noted that, in various embodiments, one or more of such fields might be not be employed, and/or further fields might be employed. It is further noted that, in various embodiments, additional and or fewer field instances may be employed. For instance, although two option request fields are shown in this example, more or fewer option request fields might be employed in various embodiments.

As will be discussed, according to various embodiments of the present invention, the user's wireless node and/or other computer receives one or more activation messages in response to such communications with the one or more servers and/or the like. In various embodiments, such activation messages may, for example, include acknowledgement of activation and/or registration, one or more connectivity settings, one or more passwords, data corresponding to option requests, and/or the like. Included among connectivity settings could, for example, be Internet settings, multimedia messaging settings, and/or the like. It is noted that, in various embodiments, connectivity settings might, for instance, be available via option request, be provided automatically as a result of registration and/or activation, and/or the like.

In various embodiments of the present invention, functionality may be implemented whereby the user's wireless node and/or other computer is able to perform communications before the receipt of such connectivity settings. Such functionality may be implanted in a number of ways.

For example, the user's wireless node and/or other computer may employ temporary connectivity settings. Such temporary connectivity settings might, in various embodiments, allow for only limited communications. For example, in various embodiments communications via such temporary connectivity settings might, perhaps in accordance with that which is discussed above, be limited to dispatch to the one or more servers and/or the like, emergency communications, and/or the like. Such temporary connectivity settings might, for example, provide for connectivity via a service provider with which the user had established a relationship (e.g., a provider with which the user had signed a service contract), a service provider other than one with which the user had established a relationship, and/or the like.

In various embodiments, all wireless nodes and/or other computers, all wireless nodes and/or other computers in a certain region, all wireless nodes and/or other computers having been manufactured by one or more certain manufacturers, and/or the like might employ for dispatch of the sort just discussed temporary connectivity settings that provided for communications via a single provider, regardless of the providers with which particular users had established relationships.

The functionality by which the user's wireless node and/or other computer could be aware of such temporary connectivity settings could be implemented in a number of ways. For example, such temporary connectivity settings might be placed on the wireless node and/or other computer during its manufacture, packaging, pre-sale preparation, and/or the like. As another example, such temporary connectivity settings might be retrieved via network, from a SIM card placed into the wireless node and/or other computer.

It is noted that, in various embodiments, separate dispatches to the one or more servers and/or the like could be performed with respect to each of registration and activation, a combined dispatch corresponding to both registration and activation could be performed, and/or the like.

It is further noted that, in various embodiments, in the case where, for instance, connectivity is not available to the wireless node and/or other computer, data relating to activation and/or registration may be stored by the wireless node and/or other computer. The wireless node and/or other computer might, for example, dispatch the data to the one or more servers and/or the like at a later time. As another example, the data might later be read from the wireless node and/or other computer at a service center, store, kiosk, and/or the like. In various embodiments, the wireless node and/or other computer might employ a counter and/or the like to count the time from when the wireless node and/or other computer is turned on to when data relating to activation and/or registration is dispatched from the wireless node and/or other computer, read from the wireless node and/or other computer, and/or the like.

Performance of Registration and/or Activation

According to various embodiments of the present invention, one or more operations involved in performing product registration and/or activation with respect to the user's wireless node and/or other computer may be performed by the one or more servers and/or the like responsive to receipt of dispatch of the sort discussed above. In various embodiments, registration update may be performed. With respect to FIG. 2 it is noted that the one or more servers and/or the like might, in various embodiments, act to place in one or more accessible stores received data, derived data, and/or the like (step 207).

It is noted that, in various embodiments, the one or more servers and/or the like might act to employ such received data, derived data, and/or the like in updating data already held in such accessible stores, in adding to data already held in such accessible stores, and/or the like. For example, in various embodiments various data relating to the wireless node and/or other computer might be placed in such accessible stores. Such data might, for instance, be placed by the manufacturer of the wireless node and/or other computer. In various embodiments, such placement of data may serve to register the wireless node and/or other computer. In various embodiments, registration update may, for example, involve the one or more servers and/or the like employing received data, derived data, and/or the like in updating such placed data.

Placed and/or updated data could, for instance, include version information, language information, nation information, region information, dates (e.g., purchase dates and/or activation dates), product identifiers (e.g., ESNs, IMEI numbers, MAC addresses, Bluetooth identifiers, and/or the like), one or more user identifiers, SIM identifiers, and/or the like, indication of model of wireless node and/or other computer, indication of one or more operators, service providers, and/or the like, version information, and/or the like.

Such accessible stores might, for instance, include product databases, consumer databases, activation databases, registration databases, authentication databases, reporting and/or analysis databases, and/or the like.

Product registration of the user's wireless node and/or other computer may, in various embodiments, include the population of one or more data fields, such population perhaps being performed via the data placement in one or more accessible stores discussed above. It is noted that, in various embodiments, such field population could include placement of one or more indications that product registration had been completed with respect to the user's wireless node and/or other computer.

Activation of the user's wireless node and/or other computer may, in various embodiments, involve the performance of one or more operations whereby the node and/or other computer receives activation messages. Such functionality may be implemented in a number of ways. For instance, the one or more servers and/or the like may, in various embodiments, act to determine the activation messages that the user's wireless node and/or other computer should receive (step 209). Such determination might, for example, involve consulting one or more accessible stores.

For example, in various embodiments the one or more servers and/or the like may consult a store that has activation messages, data to be included in activation messages, and/or the like corresponding, perhaps, to one or more operators, service providers, models of nodes and/or other computers, service plans, and/or the like in order to determine the activation messages, data to be included in activation messages, and/or the like appropriate for the user's wireless node and/or other computer. It is noted that, in various embodiments, such a consulted store might be maintained, owned, operated, and/or the like, by and/or behalf of, one or more operators, service providers, and/or the like.

Determination of appropriate activation messages may, in various embodiments, involve consideration of data received by the one or more servers and/or the like. For example, taken into consideration could be one or more received indications regarding one or more operators, service providers, model specifications, product identifiers (e.g., IMEI numbers, MAC addresses, Bluetooth identifiers, and/or the like) and/or the like.

In various embodiments, perhaps after having performed one or more operations of the sort discussed above, the one or more servers and/or the like could act to have dispatched to the user's wireless node and/or other computer notification regarding registration and/or activation. Included among such notification could, for instance, be a unique phone activation header (e.g., corresponding to one received by the one or more servers and/or the like from the wireless node and/or other computer), a service identifier, a time stamp, a password, a universal resource locator (URL), a checksum, and/or the like. It is noted that, in various embodiments, such data might be retrieved from one or more accessible stores (e.g., those of the sort discussed above).

Such a URL might, for example, provide a link to website and/or the like welcoming the user. Such a password might, for example, act to provide evidence to the user's wireless node and/or other computer, and/or the one or more servers and/or the like that activation and/or registration operations had been performed.

Such dispatch could be performed in a number of ways. For example, SMS, MMS, HTTP, SOAP, RMI, JMS, object push, and/or the like might be employed. In various embodiments, upon receipt of such a dispatch the wireless node and/or other computer might act to inform its user of such (e.g., via a GUI and/or other interface), act to consider registration and/or activation to have been performed, and/or the like.

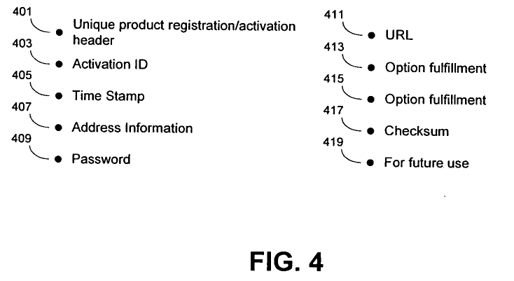

Shown in FIG. 4 are exemplary fields employable in various embodiments of the present invention for such dispatch. Shown in FIG. 4 is unique product registration/activation header field 401, activation identifier field 403, time stamp field 405, address information field 407, password field 409, URL field 411, option fulfillment field 413, option fulfillment field 415, checksum field 417, and future use field 419. It is noted that, in various embodiments, one or more of such fields might be not be employed, and/or further fields might be employed. It is further noted that, in various embodiments, additional and or fewer field instances may be employed.

Dispatch of activation messages to the user's wireless node and/or other computer (step 211) could be performed in a number of ways. For example, activation messages might include notification regarding activation and/or registration. As another example, activation messages might be sent separately from notification regarding activation and/or registration. In various embodiments, SMS, MMS, HTTP, SOAP, RMI, JMS, object push, and/or the like might be employed in activation message dispatch. Alternately or additionally, over-the-air (OTA) programming techniques could be employed in activation message dispatch, provision of connectivity settings, and/or the like.

It is noted that, in various embodiments, dispatch of activation messages (e.g., including notification regarding registration and/or activation) and/or the like could involve the action of the one or more servers and/or the like, a third party (e.g., a third party service provider), and/or the like. It is further noted that, in various embodiments, in the case where a third party performs one or more such actions, the third party might provide report of such to the one or more servers and/or the like.

It is additionally noted that, in various embodiments, such a third party might receive data including one or more phone number specifications, one or more setting type specifications, one or more model specifications, one or more operator specifications, one or more provider specifications, and/or the like corresponding to the wireless node and/or other computer.

In various embodiments, upon receipt of activation messages, one or more software modules operating on the wireless node and/or other computer may act to employ data and/or the like provided by the activation messages. It is noted that, in various embodiments, the wireless node and/or other computer might not consider registration and/or activation to have been performed until activation messages, activation notification, and/or the like had been received and/or employed.

It is noted that, in various embodiments, one or more parties might receive indication that the user's wireless node and/or other computer has been activated and/or registered. Such parties might include, for example, retailers and/or manufacturers of software, accessories, and/or the like, channel partners of the manufacturer of the wireless node and/or other computer, operators, service providers, and/or the like. Such indication might, for example, be dispatched in a manner analogous to that discussed above.

As noted above, according to various embodiments of the present invention the one or more of such servers and/or the like might be associated with the manufacturer of the wireless node and/or other computer. Received information might, in various embodiments, be used by such a manufacturer for purposes such as, for instance, warranty operations, service operations, demand supply planning, providing customer support, and/or the like.

In various embodiments, with completion of registration and/or activation the user's wireless node and/or other computer could be considered to be in a ready-to-use state. It is further noted that, in various embodiments, the one or more servers and/or the like might act to place in one or more accessible stores (e.g., those of the sort discussed above) data relating to one or more product identifiers (e.g., ESNs, IMEI numbers, MAC addresses, Bluetooth identifiers, and/or the like), operator settings, and/or the like of the user's wireless node and/or other computer.

It is noted that, in various embodiments, activation may occur as a result of completed registration, or vice versa. It is further noted that, in various embodiments, activation may be required for the wireless node and/or other computer to function properly.

Moreover, it is noted that, in various embodiments, registration may be considered complete with user input and/or the like confirming that registration is completed, in the case where an appropriate message is sent from the wireless node and/or other computer, with receipt of (e.g., at the one or more servers and/or the like) an appropriate message sent from the wireless node and/or other computer, in the case where an appropriate message is stored at the wireless node and/or other computer for later use and/or sending, with receipt at the wireless node and/or other computer of notification (e.g., dispatched by the one or more servers and/or the like) of successful registration, in the case where a registration request is dispatched by the wireless node and/or other computer but no notification is received from the one or more servers and/or the like by the wireless node and/or other computer, and/or the like. In various embodiments, such an appropriate message might, for instance, serve to request activation and/or registration, be a message containing updated and/or new data (e.g., of the sort discussed above), and/or the like.

It is further noted that, in various embodiments, activation might not be possible, allowed, and/or the like without registration, registration might not be possible, allowed, and/or the like without activation, and/or the like. Moreover, in various embodiments registration may always result in activation, or vice versa.

Option Request

According to various embodiments of the present invention, a user could be able to make one or more options requests. Such an option request could, for example, indicate a desire to receive manufacturer dialogue, product information, software updates, a startup pack, settings (e.g., connectivity settings) and/or the like. In various embodiments where a user can specify a desire to receive updates, she may be able to specify a desire to receive updates for all software on her node, for specified software, and/or the like.

The manufacturer dialogue, product information, software updates, a startup pack and/or the like might, in various embodiments, be employed in strengthening customer relationships, improving customer retention, providing customer support, and/or the like. It is rioted that, in various embodiments, a startup pack might be provided by the manufacturer of the user's wireless node and/or other computer, be created by the manufacturer of the wireless node and/or other computer, be offered by the manufacturer of the wireless node and/or other computer, and/or the like.

It is noted that, in various embodiments, the user might be offered an opportunity to make one or more options requests, for example, upon the wireless node and/or other computer being turned on for the first time, being turned on in the case where registration and/or activation has not been performed, and/or the like. With respect to screen 107 of FIG. 1 it is further noted that, in various embodiments, a user may be able to indicate that she wishes to defer her selection of one or more option request to a later time. Responsive to such a selection the wireless node and/or other computer might, in various embodiments, act to offer her the opportunity later (e.g., upon the phone being turned on, after a certain amount of time had passed, from GUI, and/or the like). According to various embodiments, the user may be able to receive additional information regarding available options.

With respect to screen 109 of FIG. 1 it is noted that, in various embodiments, the user's wireless node and/or other computer might, for example, provide her with a GUI and/or other interface she could employ to select one or more options. For instance, the wireless node and/or other computer could list each of the available options, via a GUI or the like, and for each available option provide a GUI element (e.g., a check box) whereby the user could indicate a desire to request the option. The user could, in various embodiments, have one or more opportunities to make option requests. For instance, the user might be afforded such an opportunity in conjunction with her being, perhaps as discussed above, afforded an opportunity to request registration and/or activation.

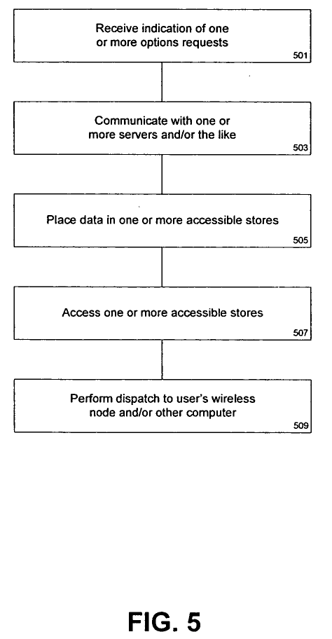

With respect to FIG. 5 it is noted that, having received indication of one or more option requests from the user (step 501), the wireless node and/or other computer could, in various embodiments, act to correspondingly communicate with the one or more servers and/or the like (step 503) (e.g., associated with the manufacturer of the wireless node and/or other computer). Such communication could, for example, be performed in a manner analogous to that discussed above with respect to request for registration and/or activation. It is noted that, in various embodiments, such communication might be combined with a request for registration and/or activation.

In various embodiments, a user making one or more options requests might be queried for additional information. The query for such additional information and/or receipt of that additional information from the user could, for example, be performed by the wireless node and/or other computer via, for instance, a GUI and/or other interface.

Such additional information might include, for example, one or more phone numbers, email addresses, messaging addresses, mailing addresses (e.g., one or more street addresses and/or post office addresses), language specifications (e.g., one or more desired languages for manufacturer dialogue, product information, software updates, a startup pack and/or the like), and/or the like.

Some or all of such additional information could, in various embodiments, be dispatched to the one or more servers and/or the like. Such dispatch might, for example, be performed in a manner analogous to that discussed above with respect to request for registration and/or activation, and/or might perhaps be combined with a request for registration and/or activation, communication regarding options requests, and/or the like.

It is noted that, in various embodiments, a user could be able to revoke, perform an unsubscribe, and/or the like with respect to a previous option request. For example, a GUI and/or other interface could be provided allowing the user to indicate a desire to do so. In various embodiments, responsive to indication of such a desire, the wireless node and/or other computer could, perhaps in a manner analogous to that discussed above, act to correspondingly communicate with the one or more servers and/or the like.

Option Fulfillment

According to various embodiments of the present invention, with receipt of communication regarding option requests indicated by the user, additional information, and/or the like, one or more operations may be performed by the one or more servers and/or the like.

It is noted that, in various embodiments, data responsive to an option request (e.g., connectivity settings) might be included in one or more activation messages, sent separately from one or more activation messages, and/or the like. Response might, in various embodiments, be dispatched in a manner analogous to that discussed above (e.g., SMS, MMS, HTTP, SOAP, RMI, JMS, object push, OTA, and/or the like might be employed).

With respect to FIG. 5 it is noted that, for example, action might be taken to place data corresponding to the option requests, received additional information, and/or the like on one or more accessible stores and/or the like (step 505). Such accessible stores might, for instance, include startup pack databases, software update databases, databases holding settings (e.g., connectivity settings), and/or the like.

In the case where, for example, a manufacturer dialogue option, product information option, and/or the like has been requested, action could be taken by the one or more servers and/or the like so that the user would receive such dialogue, product information, and/or the like via email, physical mail, messaging, and/or the like. Such dialogue, product information, and/or the like might, in various embodiments, be sent a single time, multiple times, periodically (e.g., in accordance with a schedule), and/or the like.

Accordingly, for example, action might be taken to communicate with one or more accessible stores holding manufacturer dialogue, product information, and/or the like (step 507), to access one or more accessible stores holding schedule information, and/or to dispatch manufacturer dialogue, product information, and/or the like to the user's wireless node and/or other computer (step 509). Implementation of such dispatch might, for instance, involve communication with messaging servers, email servers, telephone-voice synthesis interfaces, printing and/or physical mailing devices and/or departments, and/or the like. Dispatch might, in various embodiments be performed in a manner analogous to that discussed above. It is noted that, according to various embodiments of the present invention, various manufacturer dialogue, product information, and/or the like could be made available to users. For instance, announcements of new services, software, media, products, and/or the like might be provided. It is noted that, in various embodiments, before, during, and/or after such dispatch, one or more operations relating to options requests may be performed.

In the case where, for example, a software update option has been requested, action could be taken by the one or more servers and/or the like to keep track of current version information for various software, to keep track of various version information regarding software installed on the user's wireless node and/or other computer, and/or to determine when a newer version existed for software installed on the user's wireless node and/or other computer. Moreover, in various embodiments action could be taken to inform the user of the existence of such a newer version, to make such a newer version available for receipt by the user's wireless node and/or other computer, and/or the like. It is noted that, in various embodiments, software updates might include, for example, security updates, updates that provided changed and/or additional functionality, and/or the like.

Such functionality could be implemented in a number of ways. For example, current version information for software installed on the user's wireless node and/or other computer could be received with a request for registration and/or activation, by querying the wireless node and/or the computer (e.g., periodically), by receiving version information from the wireless node apart from a request for registration and/or activation (e.g., periodically), and/or the like.

In the case where, for example, it is determined that a newer version exists for software installed on the user's wireless node and/or other computer, the user could, in various embodiments, be informed of the situation. For instance, the one or more servers and/or the like might act to send a message and/or the like to the user, request that the user's wireless node and/or other computer inform the user (e.g., via a GUI and/or other interface) of the presence of one or more new versions, and/or the like. As another example, the user's wireless node and/or other computer might periodically query the one or more servers and/or the like regarding update availability.

In various embodiments, the user might be able to express a desire to and/or not to receive one or more, perhaps specified, new versions. The user might be able to do so, for instance, via messaging (e.g., SMS, MMS, email, and/or the like, perhaps directed to the one or more servers and/or the like), via a GUI and/or other interface provided by her wireless node and/or other computer, and/or the like. In various embodiments, in the case where the user provided such indication via a GUI and/or other interface provided by her wireless node and/or other computer, the wireless node and/or other computer could provide to the one or more servers and/or the like information regarding the user's specification. Perhaps in response to received information regarding the user's desires, one or more software updates could be provided. Such communications, providing of software, and/or the like might, in various embodiments, be performed in a manner analogous to that discussed above.

It is noted that, in various embodiments, the user's wireless node and/or other computer might, for example, act to retrieve one or more updates from the one or more servers and/or the like. As another example, in various embodiments the one or more servers might act to initiate dispatch of one or more updates to the user's wireless node and or other computer, perhaps in accordance with one or more approvals provided by the user.

In the case where, for example, a startup pack option has been requested, action could be taken (e.g., by the one or more servers and/or the like) to retrieve the startup pack from one or more accessible stores (e.g., startup pack databases), dispatch the startup pack to the user's wireless node and/or other computer, and/or the like. The dispatch of the startup pack might, in various embodiments, be performed in a manner analogous to that discussed above.

The startup pack could take a number of forms. For example, the startup pack might include multimedia (e.g., sounds, images, video, and/or the like), software, text, and/or the like. In various embodiments the startup pack could, for instance, provide tutorials, lessons, and/or the like regarding use of the wireless node and/or other computer. Topics covered by such tutorials, lessons, and/or the like might, in various embodiments, include the use of hardware, features, software, services, and/or the like. Provided tutorials, lessons, and/or the like might, in various embodiments, be interactive and/or non-interactive.

Functionality provided by the startup pack might, in various embodiments, be time-based. For instance, provided tutorials, lessons, and/or the like might act in accordance with one or more schedules, considerations of time passage, and/or the like such that, for example, certain topics might be covered after a first unit of time (e.g., a first week) had passed since registration and/or activation of the wireless node and/or other computer, other topics might be covered after a second unit of time (e.g., a second week) had passed since registration and/or activation of the wireless node and/or other computer, and so on.

As another example, topics might be covered passed on the amount of time that the wireless node and/or other computer had been used. For instance, a first set of topics might be introduced after a first specified number of hours of use, a second set of topics might be introduced after a second specified number of hours of use, and so on.

Specifications of time-based operation for the startup pack (e.g., a schedule to follow) might, in various embodiments, be retrieved from an accessible store, be provided by a system administrator and/or the like, and/or the like. In various embodiments, the startup pack might only operate for a specified period of time (e.g., for the first few days or weeks of use, for the first few days or weeks after registration and/or activation, and/or the like). Such functionality might, in various embodiments, be in accordance with specifications retrieved from an accessible store, provided by a system administrator and/or the like, and/or the like.

It is noted that, in various embodiments, the user might, perhaps via a GUI and/or other interface, be able to specify a skill level, and the operation of the startup pack might take this skill level into account. For example, certain topics might be skipped in view of a specified skill level.

It is further noted that, in various embodiments, the user may be provided with one or more keys and/or the like employable, for instance, in having her wireless node and/or other computer retrieve startup packs and/or elements thereof via, for instance, the internet. Such keys and/or the like might, in various embodiments, be limited with regard to number of downloads, time period, and/or the like.

In the case where, for example, a settings (e.g., connectivity settings) option has been requested, action could be taken by the one or more servers and/or the like to provide the appropriate settings.

For instance, the one or more servers and/or the like might, in various embodiments, act to consult one or more databases holding settings (e.g., connectivity settings), one or more databases discussed above, and/or the like in order to determine settings appropriate for the user's wireless node and/or other computer. Such databases might, in various embodiments, hold settings corresponding to one or more operators, service providers, models of nodes and/or other computers, service plans, and/or the like. It is noted that, in various embodiments, such a database might be maintained, owned, operated, and/or the like, by and/or behalf of, one or more operators, service providers, and/or the like.

Determination of appropriate settings might, in various embodiments, involve consideration of data received by the one or more servers and/or the like. For example, in various embodiments taken into consideration could be one or more received indications regarding one or more operators, service providers, model specifications, product identifiers (e.g., IMEI numbers, MAC addresses, Bluetooth identifiers, and/or the like) and/or the like.

Included in response to the option request for settings could, for example, be access point settings, telephone number settings, services settings, Internet settings, multimedia messaging settings, and/or the like.

Upon receipt of the response (e.g., including connectivity settings) one or more software modules operating on the wireless node and/or other computer may, in various embodiments, act to employ received data.

Hardware and Software

Various operations and/or the like described herein may be executed by and/or with the help of computers. Further, for example, devices described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, phone, node, and/or the like, a server, a network access point, a network multicast point, a set-top box, a personal video recorder (PVR, a game console, or the like, perhaps running an operating system such as OS X, Linux, Darwin, Windows CE, Windows XP, Windows Server 2003, Palm OS, Symbian OS, or the like, perhaps employing the Series 40 Platform, Series 60 Platform, and/or Series 90 Platform, and perhaps having support for Java and/or .Net.

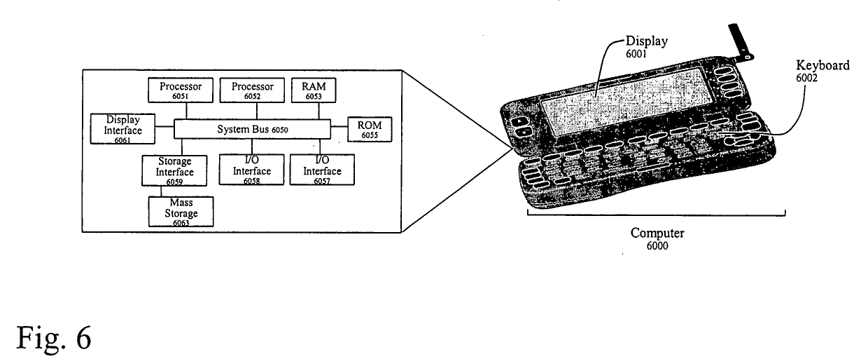

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 6000 as shown in FIG. 6 includes system bus 6050 which operatively connects two processors 6051 and 6052, random access memory 6053, read-only memory 6055, input output (I/O) interfaces 6057 and 6058, storage interface 6059, and display interface 6061. Storage interface 6059 in turn connects to mass storage 6063. Each of I/O interfaces 6057 and 6058 may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee, Bluetooth, wireless universal serial bus (WUSB), terrestrial digital video broadcast (DVB-T), satellite digital video broadcast (DVB-S), digital audio broadcast (DAB), general packet radio service (GPRS), Universal Mobile Telecommunications Service (UMTS), DVB-H, IrDA (Infrared Data Association), and/or other interface.

Mass storage 6063 may be a hard drive, optical drive, or the like. Processors 6051 and 6052 may each be a commonly known processor such as an IBM or Motorola PowerPC, an AMD Athlon, an AMD Opteron, an Intel ARM, an Intel XScale, a Transmeta Crusoe, a Transmeta Efficeon, an Intel Xenon, an Intel Itanium, or an Intel Pentium. Computer 6000 as shown in this example also includes a touch screen 6001 and a keyboard 6002. In various embodiments, a mouse, keypad, and/or interface might alternately or additionally be employed. Computer 6000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, and/or Xen according to methods known in the art. Corresponding program code might be placed on media such as, for example, DVD, CD-ROM, floppy disk, ROM, and/or memory card. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed.

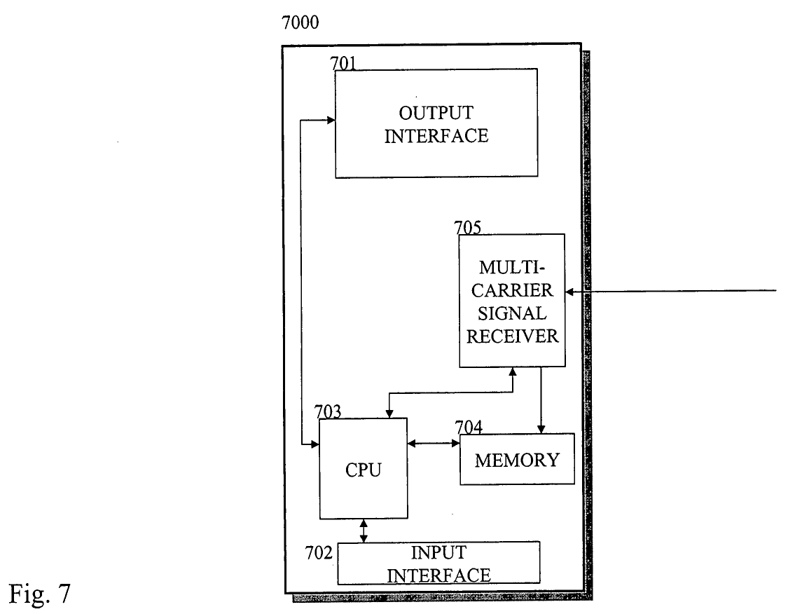

Shown in FIG. 7 is a block diagram of a terminal, an exemplary computer employable in various embodiments of the present invention. The terminal of FIG. 7 has been discussed in the foregoing. In the following, corresponding reference signs have been applied to corresponding parts. Terminal 7000 of FIG. 7 may be used in any/all of the embodiments described herein. The terminal 7000 comprises a processing unit CPU 703, a multi-carrier signal terminal part 705 and a user interface (701, 702). The multi-carrier signal terminal part 705 and the user interface (701, 702) are coupled with the processing unit CPU 703. One or more direct memory access (DMA) channels may exist between multi-carrier signal terminal part 705 and memory 704. The user interface (701, 702) comprises a display and a keyboard to enable a user to use the terminal 7000. In addition, the user interface (701, 702) comprises a microphone and a speaker for receiving and producing audio signals. The user interface (701, 702) may also comprise voice recognition (not shown).

The processing unit CPU 703 comprises a microprocessor (not shown), memory 704 and possibly software. The software can be stored in the memory 704. The microprocessor controls, on the basis of the software, the operation of the terminal 7000, such as the receiving of the data stream, the tolerance of the impulse burst noise in the data reception, displaying output in the user interface and the reading of inputs received from the user interface. The operations are described above. The hardware contains circuitry for detecting the signal, circuitry for demodulation, circuitry for detecting the impulse, circuitry for blanking those samples of the symbol where significant amount of impulse noise is present, circuitry for calculating estimates, and circuitry for performing the corrections of the corrupted data.

Still referring to FIG. 7, alternatively, middleware or software implementation can be applied. The terminal 7000 can be a hand-held device which the user can comfortably carry. Advantageously, the terminal 7000 can be a cellular mobile phone which comprises the multi-carrier signal terminal part 705 for receiving the multicast transmission stream. Therefore, the terminal 7000 may possibly interact with the service providers.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

What is claimed is:

1. A method, comprising:
receiving a request from a wireless node;
performing product registration for the wireless node; and
providing one or more activation messages to the wireless node.

2. The method of claim 1, further comprising receiving, from the wireless node, a request for a manufacturer dialog option.

3. The method of claim 1, further comprising receiving, from the wireless node, a request for a startup pack option.

4. The method of claim 1, further comprising receiving, from the wireless node, a request for a product information option.

5. The method of claim 1, further comprising receiving, from the wireless node, a request for a software update option.

6. The method of claim 1, further comprising receiving, from the wireless node, a request for connectivity settings.

7. The method of claim 2, further comprising providing manufacturer dialogue.

8. The method of claim 7, wherein the manufacturer dialogue is provided via one or more of the activation messages.

9. The method of claim 7, wherein the manufacturer dialogue is provided separate from the activation messages.

10. The method of claim 2, further comprising providing product information.

11. The method of claim 10, wherein the product information is provided via one or more of the activation messages.

12. The method of claim 10, wherein the product information is provided separate from the activation messages.

13. The method of claim 2, further comprising providing one or more software updates.

14. The method of claim 13, wherein the software updates are provided via one or more of the activation messages.

15. The method of claim 13, wherein the software updates are provided separate from the activation messages.

16. The method of claim 2, further comprising providing a startup pack.

17. The method of claim 16, wherein the startup pack is provided via one or more of the activation messages.

18. The method of claim 16, wherein the startup pack is provided separate from the activation messages.

19. The method of claim 1, further comprising providing connectivity settings.

20. The method of claim 19, wherein the connectivity settings are provided via one or more of the activation messages.

21. The method of claim 19, wherein the connectivity settings are provided separate from the activation messages.

22. The method of claim 1, wherein use of the wireless node is restricted until one or more of the activation messages have been received by the wireless node.

23. The method of claim 1, wherein a user of the wireless node is informed of one or more options available for request.

24. The method of claim 1, wherein the request seeks registration, and wherein dispatch of the request serves to activate the wireless node.

25. The method of claim 1, wherein receipt of one or more of the activation messages by the wireless node serves to activate the wireless node.

26. A method, comprising:
dispatching a request from a wireless node; and
receiving one or more activation messages at the wireless node,
wherein product registration is performed for the wireless node by one or more servers receiving the registration request.

27. The method of claim 26, further comprising dispatching, from the wireless node, a request for a manufacturer dialog option.

28. The method of claim 26, further comprising dispatching, from the wireless node, a request for a startup pack option.

29. The method of claim 26, further comprising dispatching, from the wireless node, a request for a product information option.

30. The method of claim 26, further comprising dispatching, from the wireless node, a request for a software update option.

31. The method of claim 26, further comprising dispatching, from the wireless node, a request for connectivity settings.

32. The method of claim 26, wherein use of the wireless node is restricted until one or more of the activation messages have been received.

33. The method of claim 26, wherein no data identifying a user of the wireless node is dispatched.

34. The method of claim 26, wherein a user of the wireless node is informed of one or more options available for request.

35. The method of claim 26, wherein the request seeks registration, and wherein dispatch of the request serves to activate the wireless node.

36. The method of claim 26, wherein receipt of one or more of the activation messages serves to activate the wireless node.

37. A data structure comprising:
a product identifier field;
a software version field;
a country field; and
a unique header field.

38. The data structure of claim 37, further comprising an option request field.

39. The data structure of claim 37, further comprising an operator field.

40. The data structure of claim 37, further comprising a language field.

41. The data structure of claim 37, further comprising an address information field.

42. A data structure comprising:
an activation identifier field;
a time stamp field; and
a unique header field.

43. The data structure of claim 42, further comprising an option fulfillment field.

44. The data structure of claim 42, further comprising a password field.

45. The data structure of claim 42, further comprising a universal resource locator field.

46. The data structure of claim 42, further comprising an address information field.

47. A method comprising:
providing a user interface element employable by a user for choosing to have product registration performed for a wireless node,
wherein one or more activation messages are provided to the wireless node.

48. The method of claim 47, further comprising providing a user interface element employable by the user for choosing to receive manufacturer dialogue.

49. The method of claim 47, further comprising providing a user interface element employable by the user for choosing to receive a startup pack regarding the wireless node.

50. The method of claim 47, further comprising providing a user interface element employable by the user for choosing to receive software updates.

51. The method of claim 47, further comprising providing a user interface element employable by the user for choosing to receive connectivity settings.

52. The method of claim 47, further comprising providing a user interface element employable by the user for choosing to have activation performed for the wireless node

53. The method of claim 47, further comprising providing a software interface informing the user that use of the wireless node is limited until product registration has been completed.

54. The method of claim 47, further comprising providing a software interface informing the user that use of the wireless node is limited until product activation has been completed.

55. A method, comprising:
storing, at a time of manufacture of a wireless node, data corresponding to the wireless node;
receiving a message from the wireless node, wherein the message is dispatched by the wireless node at initial startup of the wireless node; and
updating the stored data corresponding to the wireless node using at least some data included in the message.

56. The method of claim 55, further comprising performing registration of the wireless node.

57. The method of claim 55, further comprising performing activation of the wireless node.

58. The method of claim 55, wherein a registration database is employed.

59. A system, comprising:
a memory having program code stored therein; and
a processor disposed in communication with the memory for carrying out instructions in accordance with the stored program code;
wherein the program code, when executed by the processor, causes the processor to perform:
receiving a request from a wireless node;
performing product registration for the wireless node; and
providing one or more activation messages to the wireless node.

60. The system of claim 59, wherein the processor further performs receiving, from the wireless node, a request for a manufacturer dialog option.

61. The system of claim 59, wherein the processor further performs receiving, from the wireless node, a request for a startup pack option.

62. The system of claim 59, wherein the processor further performs receiving, from the wireless node, a request for a product information option.

63. The system of claim 59, wherein the processor further performs receiving, from the wireless node, a request for a software update option.

64. The system of claim 59, wherein the processor further performs receiving, from the wireless node, a request for connectivity settings

65. The system of claim 60, wherein the processor further performs providing manufacturer dialogue.

66. The system of claim 65, wherein the manufacturer dialogue is provided via one or more of the activation messages.

67. The system of claim 65, wherein the manufacturer dialogue is provided separate from the activation messages.

68. The system of claim 60, wherein the processor further performs providing product information.

69. The system of claim 68, wherein the product information is provided via one or more of the activation messages.

70. The system of claim 68, wherein the product information is provided separate from the activation messages.

71. The system of claim 60, wherein the processor further performs providing one or more software updates.

72. The system of claim 71, wherein the software updates are provided via one or more of the activation messages.

73. The system of claim 71, wherein the software updates are provided separate from the activation messages.

74. The system of claim 60, wherein the processor further performs providing a startup pack.

75. The system of claim 74, wherein the startup pack is provided via one or more of the activation messages.

76. The system of claim 74, wherein the startup pack is provided separate from the activation messages.

77. The system of claim 59, further comprising providing connectivity settings.

78. The system of claim 77, wherein the connectivity settings are provided via one or more of the activation messages.

79. The system of claim 77, wherein the connectivity settings are provided separate from the activation messages.

80. The system of claim 59, wherein use of the wireless node is restricted until one or more of the activation messages have been received by the wireless node.

81. The system of claim 59, wherein a user of the wireless node is informed of one or more options available for request.

82. The system of claim 59, wherein the request seeks registration, and wherein dispatch of the request serves to activate the wireless node.

83. The system of claim 59, wherein receipt of one or more of the activation messages by the wireless node serves to activate the wireless node.

84. A system, comprising:
a memory having program code stored therein; and
a processor disposed in communication with the memory for carrying out instructions in accordance with the stored program code;
wherein the program code, when executed by the processor, causes the processor to perform:
dispatching a request from a wireless node; and
receiving one or more activation messages at the wireless node,
wherein product registration is performed for the wireless node by one or more servers receiving the registration request.

85. The system of claim 84, wherein the processor further performs dispatching, from the wireless node, a request for a manufacturer dialog option.

86. The system of claim 84, wherein the processor further performs dispatching, from the wireless node, a request for a startup pack option.

87. The system of claim 84, wherein the processor further performs dispatching, from the wireless node, a request for a product information option.

88. The system of claim 84, wherein the processor further performs dispatching, from the wireless node, a request for a software update option.

89. The system of claim 84, wherein the processor further performs dispatching, from the wireless node, a request for connectivity settings.

90. The system of claim 84, wherein use of the wireless node is restricted until one or more of the activation messages have been received.

91. The system of claim 84, wherein no data identifying a user of the wireless node is dispatched.

92. The system of claim 84, wherein a user of the wireless node is informed of one or more options available for request.

93. The system of claim 84, wherein the request seeks registration, and wherein dispatch of the request serves to activate the wireless node.

94. The system of claim 84, wherein receipt of one or more of the activation messages serves to activate the wireless node.

95. A system, comprising:
a memory having program code stored therein; and
a processor disposed in communication with the memory for carrying out instructions in accordance with the stored program code;
wherein the program code, when executed by the processor, causes the processor to perform:
storing, at a time of manufacture of a wireless node, data corresponding to the wireless node;
receiving a message from the wireless node, wherein the message is dispatched by the wireless node at initial startup of the wireless node; and
updating the stored data corresponding to the wireless node using at least some data included in the message.

96. The system of claim 95, wherein the processor further performs registration of the wireless node.

97. The system of claim 95, further wherein the processor further performs activation of the wireless node.

98. The system of claim 95, wherein a registration database is employed.

99. An article of manufacture comprising a computer readable medium containing program code that when executed causes a server to perform:
receiving a request from a wireless node;
performing product registration for the wireless node; and
providing one or more activation messages to the wireless node.

100. An article of manufacture comprising a computer readable medium containing program code that when executed causes a wireless node to perform:
dispatching a request from a wireless node; and
receiving one or more activation messages at the wireless node,
wherein product registration is performed for the wireless node by one or more servers receiving the registration request.
